(19) United States
(12) Patent Application Publication
(10) Pub. No.: US 2014/0186633 A1
(43) Pub. Date: Jul. 3, 2014

(54) Color Match Verification of Multi-Layer Coatings Utilizing Precoated Color Chips

(71) Applicant: PPG INDUSTRIES OHIO, INC., Cleveland, OH (US)

(72) Inventor: Michael J. Henry, Hinckley, OH (US)

(73) Assignee: PPG INDUSTRIES OHIO, INC., Cleveland, OH (US)

(21) Appl. No.: 13/731,565

(22) Filed: Dec. 31, 2012

(51) Int. Cl. B32B 5/00

(52) U.S. Cl. CPC B32B 5/00
USPC 428/411.1; 427/8; 427/256; 427/265

(57) ABSTRACT

Precoated color chips having a reference colored basecoat and at least one reference effect appearance midcoat partially covering a portion of the basecoat are used to verify the colors of multi-layer automotive coatings when they are applied to automotive components. Visual characteristics of multi-layer automotive coatings may be verified by comparing an applied colored basecoat to the corresponding reference colored basecoat of the precoated color chips, followed by comparing an applied effect appearance midcoat to the corresponding reference effect appearance midcoat of the precoated color chips. Methods of making the precoated color chips are also disclosed.

### FIELD OF THE INVENTION

The present invention relates to verification of visual characteristics of multi-layer automotive coatings utilizing precoated color chips in the automotive refinish and restoration industry.

### BACKGROUND OF THE INVENTION

One of the most difficult and time consuming processes in automotive collision repair paint shops is the repair of multiple-stage colors. For example, three stage or tri-coat colors are typically produced in automotive original equipment manufacturer (OEM) assembly plants by applying a basecoat color over the vehicle exterior, followed by a midcoat layer of translucent color, which can contain effect pigments such as pearlescent micas or combinations of pigments that are designed to work with the base color layer to achieve dramatic finished effects. The basecoat and midcoat layers may then be sealed with a clear topcoat to achieve a durable high gloss surface layer. Successful repair of such colors utilizing conventional techniques demands time, patience and skill.

Reference chips are conventionally used to simulate the total combined finished effect of multi-layer or tri-coat color formulations. However, such reference chips make no attempt to reference the separate layers of color that constitute the final optical effect of the color formulas necessary to repair OEM colors, and can be difficult to use in predicting the final result of the color achieved by the applied formulation. Conventional color chips used to represent multi-layer automotive coatings thus show only the final overall combined finish effect of the multi-layer coating. Such multi-layer color chips are not ideal because the critical solid color basecoat color match is not represented independently and cannot be judged in comparison with the initial basecoat paint layer that has been mixed and applied to an automotive component. If the mix or application of a solid color basecoat color layer is off-color by even a small degree, the desired finished coloristic effect of the formula may not be achievable. Accordingly, conventional multi-layer color reference chips are not sufficient for colors that are difficult to repair.

Current industry practice includes the on-site spray of experimental test panels using multiple combinations of basecoat and midcoat paint layers in order to simulate the number of coats of basecoat and midcoat that are necessary to achieve a color match to a vehicle being repaired. Such procedures add a significant amount of time to the formula selection process, and the desired result is often not achieved with successive attempts. A significant problem with this practice is the particular experimental panel produced on-site is unique to that repair and that painter. Such panels are not intended to be reused on another repair or utilized by another painter who may have a different painting technique.

Because the current state of the industry solution for repairing multi-layer automotive coatings relies on the use of color chips that represent only the final finish effect of a selected paint formulation, and the recommended practice involves the creation of experimental test panels for each time a multi-layer color is repaired, there is a need for a solution that reduces the time required to repair these colors and improves the accuracy and repeatability of the repair process.

### SUMMARY OF THE INVENTION

An aspect of the invention provides a method of verifying visual characteristics of a multi-layer automotive coating as it is applied to an automotive component comprising: providing a precoated color chip comprising a reference colored basecoat on a substrate and at least one reference effect appearance midcoat partially covering the reference colored basecoat; applying a colored basecoat composition onto the automotive component; comparing an exposed portion of the reference colored basecoat of the precoated color chip with the applied colored basecoat to provide a first color match verification; applying at least one effect appearance midcoat composition onto the automotive component over the applied colored basecoat; and comparing the at least one reference effect appearance midcoat of the precoated color chip with the at least one applied effect appearance midcoat to provide a second color match verification.

Another aspect of the invention provides a precoated color chip for color matching of a multi-coat finish on an automotive component comprising: a substrate; a reference colored basecoat corresponding to a colored basecoat to be applied to the automotive component covering at least a portion of the substrate; and at least one reference effect appearance midcoat corresponding to an effect appearance midcoat to be applied to the automotive component partially covering a portion of the reference colored basecoat.

A further aspect of the invention provides a method of making a precoated automotive color chip comprising: applying a reference colored basecoat on a master sheet substrate; applying at least one reference effect appearance midcoat on a portion of the reference colored basecoat; and dividing the master sheet substrate into multiple precoated color chips, wherein each precoated color chip comprises an exposed portion of the reference colored basecoat and a covered portion of the reference colored basecoat covered by the at least one reference effect appearance midcoat.

Another aspect of the invention provides a master sheet for producing multiple precoated automotive color chips, the master sheet comprising: a master sheet substrate; a reference colored basecoat applied on the master sheet substrate; and at least one reference effect appearance midcoat applied on a portion of the reference colored basecoat, wherein the at least one reference effect appearance midcoat is arranged to partially cover the reference colored basecoat on each precoated color chip when the master sheet is divided into the multiple precoated color chips.

### BRIEF DESCRIPTION OF THE DRAWINGS

FIG. 1 is a partially schematic isometric view illustrating a precoated multi-layer color chip in accordance with an embodiment of the present invention.

FIG. 2 is a partially schematic isometric view illustrating a precoated multi-layer color chip in accordance with another embodiment of the present invention.

FIG. 3 is a partially schematic isometric view illustrating a master sheet from which multiple precoated multilayer color chips may be cut in accordance with an embodiment of the present invention.

FIG. 4 is a flowchart illustrating a color verification process in accordance with an embodiment of the present invention.

### DETAILED DESCRIPTION

An embodiment of the present invention provides a color match verification process in which a multi-layer coating comprising a colored basecoat and at least one effect appearance midcoat is applied in separate steps to an article such as an automotive component. At each coating step, the applied colored basecoat or the applied effect appearance midcoat is compared with a corresponding portion of a precoated color chip. The precoated color chips comprise a substrate, a reference colored basecoat, and at least one reference effect appearance midcoat over a portion of the reference colored basecoat. The multi-layer coatings of the present invention include at least one colored basecoat and at least one effect appearance midcoat.

As used herein, the term “precoated”, when referring to the color chips of the present invention, means a color chip comprising a reference colored basecoat and a reference effect appearance midcoat that has been produced prior to a color match verification operation. The precoated color chips are produced under controlled coatings application conditions and manufactured to tight tolerances of minimal variation to assure copy-to-copy consistency. The visual characteristics of the reference colored basecoat and reference effect appearance midcoat are controlled, repeatable and reliable. In certain embodiments, the precoated color chips are produced separately off-site from the article-coating operation using automated coating equipment.

As used herein, the term “color match verification” means evaluation of the visual characteristics of coatings applied to an article such as an automotive component in comparison with a corresponding reference coating previously applied to a precoated color chip. A first color match verification occurs when the colored basecoat is applied to the article, and then compared with the reference colored basecoat of the precoated color chip. A second color match verification occurs when the effect appearance layer is applied to the article over the basecoat, and then compared with the reference effect appearance midcoat of the precoated color chip.

As used herein, the term “automotive component” means a coated component of a car, truck or any other type of vehicle, including exterior components such as automotive sheet panels and trim and interior components such as panels, bumpers and trim.

The present invention provides precoated color chips that represent the specified number of coats for each constitute layer comprising a multi-layer paint formulation by displaying discrete bands of color for each color layer. The accuracy of the color of these layers is achieved by a controlled and repeatable manufacturing process that is checked so as the individual chips are held within a tight tolerance to reference color standards. In certain embodiments, the precoated color chips are manufactured by automated processes that ensure consistency and repeatability of the coating layers that are applied on the precoated color chips. Using one chip comprised of discrete bands representing the critical color application stages in the multi-layer color repair saves time and improves accuracy as the painter can use this chip to check and align the repair color in-process color at each of the critical steps in the repair.

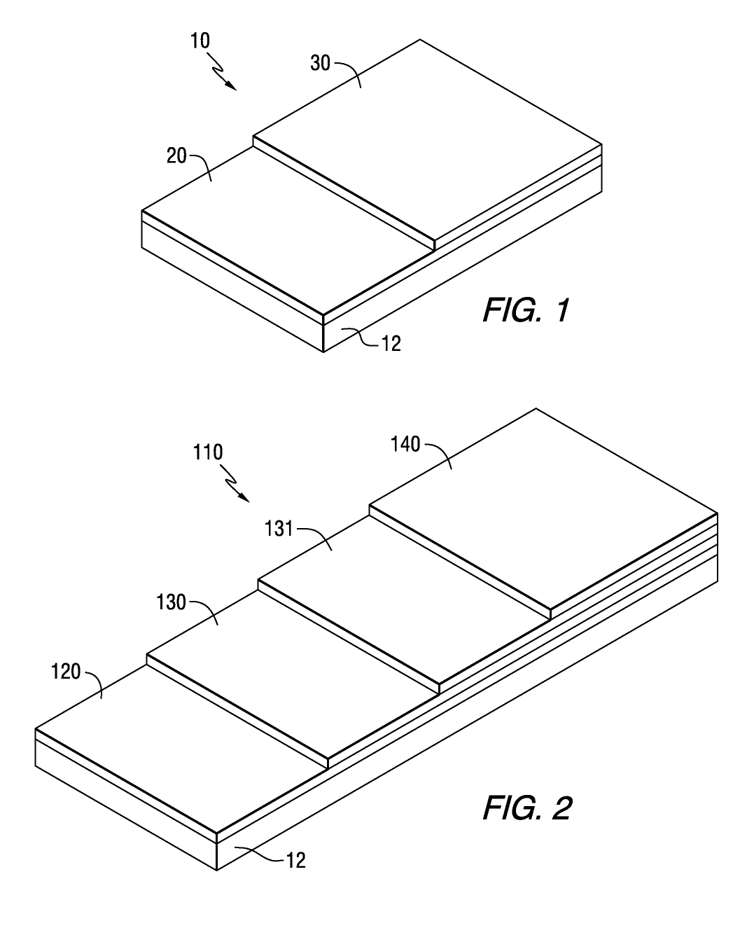

FIG. 1 illustrates a precoated color chip 10 in accordance with an embodiment of the present invention. The precoated color chip 10 comprises a substrate 12 having a reference colored basecoat 20 applied thereon. A reference effect appearance midcoat 30 is applied over a portion of the reference colored basecoat 20, while leaving a portion of the basecoat 20 exposed.

The substrate 12 may have any suitable dimensions, for example, a length of from 2 to 20 cm or more, a width of from 2 to 10 cm or more, and a thickness of from 0.1 to 10 mm, e.g., from 0.2 or 0.5 to 1 or 2 mm. The substrate 12 may be made of any suitable material such as paper, plastic, metal and the like.

The reference colored basecoat 20 may comprise any suitable color, such as white, red or another solid or metallic color. For example, some suitable solvent-based coating compositions include isocyanate hydroxyl, epoxy amine, anhydride hydroxyl, acrylate, acrylic/CAB, alkyd, acetylacetonate ketamine, acrylic lacquer, vinyl butylaldehyde, epoxy/acid, melamine hydroxyl, silane, acrylic urethane and the like. Some suitable water-based compositions include isocyanate hydroxyl, epoxy amine, acrylic latex, melamine hydroxyl, polyurethane dispersions and the like.

In certain embodiments, the reference colored basecoat 20 may have a dry film thickness of from 0.5 to 5 mils (0.0127 to 0.127 mm), for example, from 1 to 2 mils (0.0254 to 0.0508 mm).

The reference effect appearance midcoat 30 may comprise solvent-based or water-based compositions that may be the same or similar to the types of compositions described above for the reference colored basecoat 20.

In certain embodiments, the reference colored basecoat 20 and/or reference effect appearance midcoat 30 may have gonio-apparent properties. As used herein, the term “gonio-apparent properties” refers to the appearance of a coating that exhibits the property of angle-dependent color change, i.e., the color changes upon variation of the angle of incident light, or as the viewing angle of the observer is shifted. Gonio-apparent properties may result from, for example, the presence of metallic effect pigments, such as particles of aluminum, zinc, copper, brass, lead, bronze, stainless steel and the like, and/or the presence of interference pigments, such as pigments that comprise multiple layers of reflective material, e.g., aluminum or chromium, sandwiching layers of dielectric material, e.g., metal fluoride, metal oxide or magnetic layers, and absorptive layers, e.g., mica or coated mica.

In certain embodiments, the reference effect appearance midcoat 30 may comprise a clear binder with translucent solid color or gonio-effect pigments such as mica, metal flake, crystal effect pigments, interference pigments, and the like. Some examples of suitable clear binders include isocyanate hydroxyl, epoxy amine, anhydride hydroxyl, acrylate, acrylic/CAB, alkyd, acetylacetonate ketamine, acrylic lacquer, vinyl butylaldehyde, epoxy/acid, melamine hydroxyl, silane, acrylic urethane and the like. The gonio-effect pigments typically comprise from 5 to 75 weight percent of the midcoat composition, based upon the total solids content of the midcoat, with the balance comprising from 25 to 95 weight percent of the clear binder and any other components conventionally found in gonio-apparent coatings. In certain embodiments, the gonio-effect pigment may comprise 10 to 25 weight percent of the midcoat composition.

In certain embodiments, the reference effect appearance midcoat 30 has a dry film thickness of from 0.5 to 5 mils (0.0127 to 0.127 mm), for example, from 0.5 to 2 mils (0.0127 to 0.0508 mm).

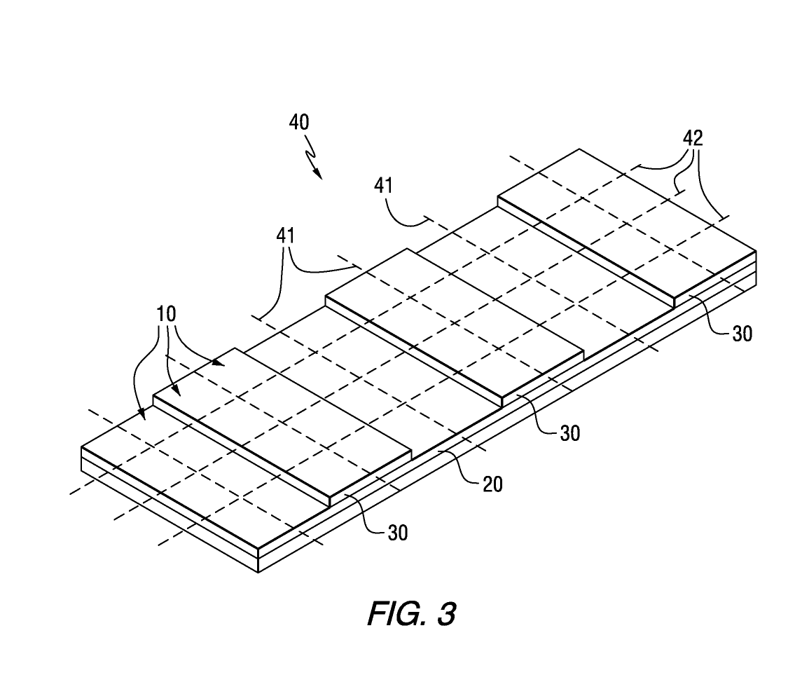

FIG. 2 illustrates a multi-layered precoated color chip 110 in accordance with another embodiment of the invention. The precoated color chip 110 comprises a substrate 112 having a reference colored basecoat 120 applied thereto. Two reference effect appearance midcoats 130 and 131 are applied over portions of the reference colored basecoat 120. As shown in FIG. 2, the first reference effect appearance midcoat 130 is applied directly on the reference colored basecoat 120, while leaving a portion of the reference colored basecoat 120 exposed. The second reference effect appearance midcoat 131 is applied directly on the first reference effect appearance midcoat 130, while leaving a portion of the first reference colored midcoat 130 exposed. Certain types of coatings may be sensitive to variations in the thickness of the midcoat layer(s), and multiple layers of the reference effect appearance midcoat 130 and 131 can be included in the precoated color chips to demonstrate the finished color at a higher midcoat film build.

The substrate 112, reference colored basecoat 120 and reference effect appearance midcoats 130 and 131 shown in FIG. 2 may have dimensions, compositions and visual characteristics similar to the substrate 12, reference colored basecoat 20 and reference effect appearance midcoat 30 of FIG. 1. Each reference effect appearance midcoat 130 and 131 may have a dry film thickness of from 0.2 to 5 mils (0.0051 to 0.127 mm), for example, from 0.5 to 1.0 mils (0.0127 to 0.0254 mm). The total dry film thickness of the reference effect appearance midcoats 130 and 131 may be from 0.4 to 10 mils (0.0102 to 0.254 mm), for example, from 0.4 to 2 mils (0.0102 to 0.0508 mm).

Although a single reference effect appearance midcoat 30 is shown in FIG. 1, and two reference effect appearance midcoats 130 and 131 are shown in FIG. 2, any suitable number of reference effect appearance midcoats may be used in accordance with the present invention. Where multiple reference effect appearance midcoats are used, they may be of the same or different composition, and may have the same or different dry film thicknesses.

As shown in FIG. 2, a clearcoat 140 may be applied on a portion of the substrate 112. In the embodiment shown, the clearcoat 140 is applied directly on a portion of the reference effect appearance midcoat 131, while leaving another portion of the reference effect appearance midcoat 131 exposed.

The clearcoat 140 may have a dry film thickness from 0.5 to 5 mils (0.0127 to 0.127 mm), for example, from 0.7 to 1.5 mils (0.0178 to 0.0381 mm). The clearcoat 140 may comprise isocyanate hydroxyl, epoxy amine, anhydride hydroxyl, acrylate, acrylic/CAB, alkyd, acetylacetonate ketamine, acrylic lacquer, vinyl butylaldehyde, epoxy/acid, melamine hydroxyl, silane, acrylic urethane or the like.

The precoated color chips may be manufactured using any suitable coating process that deposits the reference colored basecoat and reference effect appearance midcoat compositions on the substrate using such processes as blade, die cut reservoir, curtain coating, and the like. In certain embodiments the precoated color chips can be manufactured using an atomizing spray process using masks, barriers or shields to produce the exposed reference basecoat region and the reference midcoat region(s). Those skilled in the art will also recognize variations of the spray application processes to produce precoated color chips having the desired finish effects.

FIG. 3 schematically illustrates the production of multiple precoated multi-layer color chips 10 from a master sheet 40 in accordance with an embodiment of the present invention. The master sheet 40 includes a substrate 12 covered by a reference colored basecoat 20. When the substrate is paper or another porous material, a conventional sealer coating may be applied to seal the porous substrate. The reference colored basecoat may be applied to the substrate by any suitable technique such as spraying, blade coating, brushing and the like. For example, the reference colored basecoat composition may be applied by a non-spraying method, such as blade coating, to provide a durable film layer, followed by the application of a matt clearcoat layer to produce a non-glossy appearance simulating a spray-applied coating. Such a two-step process provides the non-spray applied reference colored basecoat with the appearance of a spray-applied finish.

Selected regions of the reference colored basecoat 20 are then coated with strips or bands of a reference effect appearance midcoat 30. Each of the reference effect appearance midcoat compositions may be applied to a portion of the reference colored basecoat by masking off a portion of the underlying basecoat and/or midcoat layers and blade coating, spraying or the like. In certain embodiments, the reference effect appearance midcoat layers are applied by a non-spraying technique such as blade coating. A matt clearcoat may be applied over the blade coatings to simulate a sprayed finish.

In certain embodiments, the substrate 12, reference colored basecoat 20, and reference effect appearance midcoat bands 30 may correspond to the elements illustrated in FIG. 1, or variations thereof such as the embodiment shown in FIG. 2. In certain embodiments, the application of the reference colored basecoat and the application of the reference effect appearance midcoat layer(s) are performed automatically, for example, by known robotic blade coating, spray coating or similar operations.

As shown in FIG. 3, the master sheet 40 may be divided into several segments, with each segment representing a single precoated color chip 10. In the embodiment shown, the master sheet 40 may be cut or otherwise divided along lines 41 running parallel with the reference effect appearance midcoat bands 30, and along lines 42 running perpendicular to the reference effect appearance midcoat bands 30. In this manner, a single master sheet 40 may be used to provide multiple precoated color chips 10. The number of precoated color chips 10 provided from a single master sheet 40 may be varied as desired. Although a portion of the master sheet 40 shown in FIG. 3 is divided into twenty individual precoated color chips 10 by the lines 41 and 42, any other suitable number of rows and columns of precoated color chips 10 may be provided from a suitably sized master sheet 40. In certain embodiments, the substrate 12 of the master sheet 40 may be provided in rectangular form having any suitable length and width. For example, a typical master sheet 40 may have a length of from 10 cm to 10 m or 10 m or more and a width of from 5 cm to 5 m or more. In certain embodiments, the substrate 12 of the master sheet 40 may be provided in continuous or semi-continuous form, such as from a roll of the substrate material.

The master sheet 40 as shown in FIG. 3 may be produced by various coating methods. For example, the substrate 12 may be initially coated with the reference colored basecoat 20 by blade coating or any other suitable application technique. After the basecoat 20 is sufficiently dry or cured, portions thereof may be masked off or otherwise covered, followed by application of the reference effect appearance midcoat bands 30 to the un-masked or un-covered regions by blade coating, spray coating or the like. The bands of masking material or coverings are then removed to reveal the underlying reference colored basecoat 20 in the masked or covered regions. The resultant master sheet 40 thus includes exposed bands of the reference basecoat 20, as well as bands of the reference effect appearance midcoat 30. If multiple reference colored midcoat layers are desired, such as shown in the embodiment of FIG. 2, additional masking steps may be performed in order to produce multiple reference colored midcoat bands having different dry film thicknesses. Similarly, if a clearcoat layer is to be applied, additional masking steps may be used.

After the reference colored basecoat, reference effect appearance midcoat(s), and any clearcoat have been applied to the substrate of the master sheet 40, the master sheet 40 may be divided by any suitable method into individual precoated color chips 10. For example, the master sheet 40 may be cut by methods such as die cutting or the like.

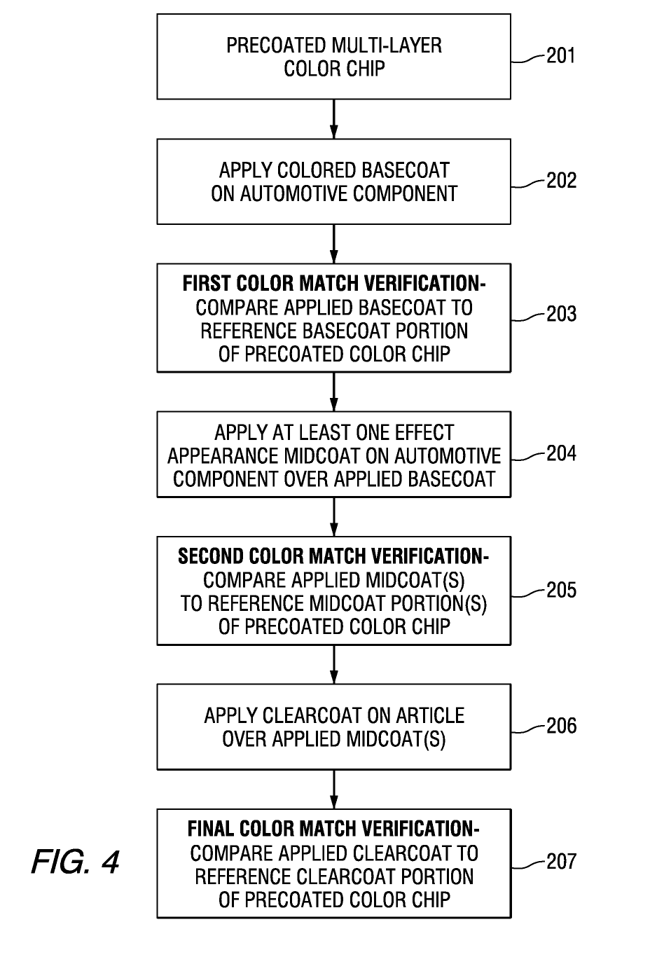

In accordance with certain embodiments of the invention, a precoated color chip may be used in a color matching process illustrated in the flowchart of FIG. 4. In the first step 201 shown in FIG. 4, a precoated multi-layer color chip as described above is provided.

In the next step 202, a colored basecoat is applied on an article by any suitable method known in the art. In the next step 203, the applied basecoat is compared to the reference basecoat portion of the precoated color chip. In the next step 204, at least one effect appearance midcoat is applied on the article over the applied basecoat. In the next step 205, each applied midcoat is compared to the corresponding reference midcoat portion of the precoated color chip. In the next step 206, a clearcoat may optionally be applied on the article over the applied midcoat(s). In the final step 207 shown in FIG. 4, the applied clearcoat and underlying midcoat(s) and basecoat are compared to the clearcoat portion of the precoated color chip.

Each of the comparing steps 203, 205 and 207 shown in FIG. 4 may involve color match verification. The visual characteristics to be compared may include color or spectral characteristics and appearance characteristics. Color/spectral characteristics are known in the coatings art, and include solid colors and gonio-apparent colors such as metallic and pearlescent colors. When evaluating gonio-apparent colors, it is often necessary to view such coatings from multiple angles and/or using multiple angles of incident light because their appearances are angle-dependent. Such characteristics are often measured or analyzed in the visual range of the electromagnetic spectrum, but in some cases may be measured or analyzed in other ranges of the electromagnetic spectrum, such as infrared and ultraviolet ranges. Examples of appearance characteristics include gloss, haze, distinctiveness of image, mottling, transparency, and the like.

The precoated color chips of the present invention provide a number of advantages. For example, the color chip provides a representation of the desired color match at each step in the multi-coat application process. Color chips that only represent the overall combined finish effect are not the ideal situation because the critical basecoat color match is not present and cannot be judged in comparison with the actual basecoat applied to an article during a coating operation. If the mix or application of basecoat layer is off-color by even a small degree, the desired finished coloristic effect of the formula may not be achievable. Therefore, having a basecoat color match reference at this critical first step is advantageous because any error can be corrected before additional time and material are expended on the subsequent midcoat and final clearcoat layers that are applied. The precoated color chips of the invention are advantageous because they may also show the combined finished effect with application of midcoat layers at the recommended film thickness. The precoated multiple-coat color chips of the present invention provide a controlled and repeatable manufacturing process. The precoated chips may be designed to reveal the color of the independent layers that combine to create the finished optical appearance of the selected multiple-coat formula by using distinct bands revealing the exact color that will result from applying the specified number of coats for each layer.

For purposes of this detailed description, it is to be understood that the invention may assume various alternative variations and step sequences, except where expressly specified to the contrary. Moreover, unless otherwise indicated, all numbers expressing quantities used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

It will be readily appreciated by those skilled in the art that modifications may be made to the invention without departing from the concepts disclosed in the foregoing description. Such modifications are to be considered as included within the following claims unless the claims, by their language, expressly state otherwise. Accordingly, the particular embodiments described in detail herein are illustrative only and are not limiting to the scope of the invention which is to be given the full breadth of the appended claims and any and all equivalents thereof.

1. A method of verifying visual characteristics of a multi-layer automotive coating as it is applied to an automotive component comprising:
applying a colored basecoat composition onto the automotive component;
comparing the applied colored basecoat with an exposed portion of a reference colored basecoat of a precoated color chip to provide a first color match verification, wherein the precoated color chip comprises the reference colored basecoat on a substrate and at least one reference effect appearance midcoat partially covering the reference colored basecoat;
applying at least one effect appearance midcoat composition onto the automotive component over the applied colored basecoat; and
comparing the at least one applied effect appearance midcoat with the at least one reference effect appearance midcoat of the precoated color chip to provide a second color match verification, wherein the application of the colored basecoat composition and the application of the at least one effect appearance midcoat composition are performed at a separate site from production of the precoated color chip.

2. The method of claim 1, wherein the at least one reference effect appearance midcoat has gonio-apparent properties.

3. The method of claim 1, wherein the at least one reference effect appearance midcoat comprises a clear binder and gonio-effect pigments.

4. The method of claim 1, wherein the at least one reference effect appearance midcoat comprises a translucent solid color.

5. The method of claim 1, wherein the at least one reference effect appearance midcoat comprises a blade coating.

6. The method of claim 5, wherein the at least one reference effect appearance midcoat further comprises a matt clearcoat over the blade coating.

7. The method of claim 1, wherein the reference colored basecoat has a solid color.

8. The method of claim 1, wherein the reference colored basecoat has gonio-apparent properties.

9. The method of claim 1, wherein the reference colored basecoat comprises a blade coating.

10. The method of claim 9, wherein the reference colored basecoat further comprises a matt clearcoat over the blade coating.

11. The method of claim 1, wherein the precoated color chip comprises at least two of the reference effect appearance midcoats, a first one of the reference effect appearance midcoats is applied on the reference colored basecoat, and a second one of the reference effect appearance midcoats is applied on a portion of the first reference effect appearance midcoat.

12. The method of claim 11, wherein the first reference effect appearance midcoat and the second reference effect appearance midcoat are compared to the at least one applied effect appearance midcoat.

13. The method of claim 1, further comprising applying a clearcoat over the at least one applied effect appearance midcoat, wherein the precoated color chip comprises a reference clearcoat over at least a portion of the at least one reference effect appearance midcoat, and the applied clearcoat applied on the article and its underlying colored midcoat are compared with the reference clearcoat and underlying at least one reference effect appearance midcoat of the precoated color chip.

14. The method of claim 1, wherein the automotive component is an exterior panel of a vehicle.

15. A precoated color chip for color matching of a multi-coat finish on an automotive component comprising:
a substrate;
a reference colored basecoat corresponding to a colored basecoat to be applied to the automotive component covering at least a portion of the substrate; and
at least one reference effect appearance midcoat corresponding to an effect appearance midcoat to be applied to the automotive component partially covering a portion of the reference colored basecoat.

16. A method of making a precoated automotive color chip comprising:
applying a reference colored basecoat on a master sheet substrate;
applying at least one reference effect appearance midcoat on a portion of the reference colored basecoat; and
dividing the master sheet substrate into multiple precoated color chips, wherein each precoated color chip comprises an exposed portion of the reference colored basecoat and a covered portion of the reference colored basecoat covered by the at least one reference effect appearance midcoat.

17. The method of claim 16, wherein the reference colored basecoat is applied by blade coating.

18. The method of claim 17, further comprising applying a matt clearcoat over the blade coated reference colored basecoat.

19. The method of claim 16, wherein the at least one reference effect appearance midcoat is applied by blade coating.

20. The method of claim 19, further comprising applying a matt clearcoat over the blade coated reference effect appearance midcoat.

21. A master sheet for producing multiple precoated automotive color chips, the master sheet comprising:
a master sheet substrate;
a reference colored basecoat applied on the master sheet substrate; and
at least one reference effect appearance midcoat applied on a portion of the reference colored basecoat, wherein the at least one reference effect appearance midcoat is arranged to partially cover the reference colored basecoat on each precoated color chip when the master sheet is divided into the multiple precoated color chips.

22. A method of verifying visual characteristics of a multi-layer automotive coating as it is applied to an automotive component comprising:
applying a colored basecoat composition onto the automotive component;
comparing the applied colored basecoat with an exposed portion of a reference colored basecoat of a precoated color chip to provide a first color match verification, wherein the precoated color chip comprises the reference colored basecoat on a substrate and at least one reference effect appearance midcoat partially covering the reference colored basecoat;
applying at least one effect appearance midcoat composition onto the automotive component over the applied colored basecoat; and
comparing the at least one applied effect appearance midcoat with the at least one reference effect appearance midcoat of the precoated color chip to provide a second color match verification, wherein the application of the colored basecoat composition and the application of the at least one effect appearance midcoat composition are performed by different application equipment than used to produce the precoated color chip.

23. The method of claim 22, wherein the precoated color chip is produced by automated coating equipment.
